(19) United States
(12) Patent Application Publication
(10) Pub. No.: US 2016/0311239 A1
(43) Pub. Date: Oct. 27, 2016

(54) SELF-PROPELLED PRINTER AND SELF-PROPELLED IMPRINTER

(71) Applicant: Zuta Labs Ltd., Jerusalem (IL)

(72) Inventors: Tuvia ELBAUM, Jerusalem (IL); Matan CASPI, Jerusalem (IL); Leon ROSENGARTEN, Jerusalem (IL); Gilad SCHNURMACHER, Jerusalem (IL)

(73) Assignee: Zuta Labs Ltd., Jerusalem (IL)

(21) Appl. No.: 15/197,031

(22) Filed: Jun. 29, 2016

Related U.S. Application Data
(63) Continuation of application No. PCT/IL2015/050078, filed on Jan. 22, 2015.
(60) Provisional application No. 61/930,971, filed on Jan. 24, 2014.

(51) Int. Cl. B41J 29/38; G06K 15/00; B41J 3/36

(52) U.S. Cl. CPC B41J 29/38; B41J 3/36; G06K 15/4025

(57) ABSTRACT

A self-propelled printer comprises a processor; an interface communicatively connected to the processor for providing at least information respective of a surface to be printed; a memory communicatively connected to the processor, the memory containing instructions that, when executed by the processor, configure the self-propelled printer to at least render an image for printing respective of at least a portion of the information received via the interface; a print head communicatively connected to the processer for printing on the surface based on the rendered image; a motor control unit communicatively connected to the processor for propelling the self-propelled printer via at least one motor based on the rendered image; and at least a rotary element connected to the at least one motor, wherein the rotary element is configured to move in at least two directions with respect to the surface based on movement of the at least one motor.

### CROSS REFERENCE TO RELATED APPLICATIONS

This application is a continuation of Application No. PCT/IL2015/050078 filed on Jan. 22, 2015 which claims the benefit of U.S. provisional patent application No. 61/930,971, filed on Jan. 24, 2014, the contents of which are incorporated herein by reference.

### TECHNICAL FIELD

The invention relates to mobile printers/imprinters, and more particularly to self-propelled printers and imprinters.

### BACKGROUND

Typical printers are stationary devices which contain paper that, either in sheets or continuously, moves through a printing mechanism. These stationary printers, even when compact, are bulky and meant for use as a desktop device at minimum. Another category of printers is mobile printers, which are lighter weight than stationary printers and, intended to be carried around, therefore being suitable for mobile applications. Such mobile printers are described, for example, in U.S. Pat. No. 5,825,995. Some existing mobile printers are intended to be guided by the user along a surface. These guided mobile printers require user assistance and, as a result, may require more time and effort to use, and may be subject to human error during use.

The design of other existing mobile printers requires that the print head move across the surface while the printer propels itself along the length of the surface as printing continues. U.S. Pat. No. 6,695,445 describes, for instance, a self-propelling printer that is movable over an oversized printable sheet or substrate. It is also equipped with detectors to detect its position with respect to the sheet or substrate. In other cases, imprinters are used to imprint signs on a surface regardless of whether the surface is paper, cloth, or another type of surface. Existing self-propelling printers typically need to move over the entire surface in order to successfully print on even small portions of that surface.

Thus, there is a need in the art for such portable printers and imprinters that can be used by a user outside of an office setting. It would be desirable if such portable printers and imprinters could be self-propelled. It would be further advantageous for such self-propelled printers and imprinters to be capable of moving over only the portions of a surface to be printed upon rather than the entire surface.

### BRIEF DESCRIPTION OF THE DRAWINGS

The subject matter disclosed herein is particularly pointed out and distinctly claimed in the claims at the conclusion of the specification. The foregoing and other objects, features and advantages of the disclosed embodiments will be apparent from the following detailed description taken in conjunction with the accompanying drawings.

FIGS. 1A-1D show printing of a page by a self-propelled printer according to an embodiment.

FIGS. 2A-2C show printing of a page by a self-propelled printer according to an embodiment.

FIG. 3 is a block diagram of a self-propelled printer according to an embodiment.

FIG. 4 is a block diagram of a self-propelled printer according to an embodiment.

FIG. 5 is a flowchart describing the operation of a self-propelled printer according to an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

It should be understood that the following description includes the terms “printer” and “printing” for illustrative purposes and without limitation on the various disclosed embodiments. Printing, imprinting, and other types of marking may be conducted by a printer or imprinter without departing from the scope of the disclosed embodiments. Types of printing and imprinting may include, but are not limited to, ink printing, laser printing, engraving, and so on.

A self-propelled printer, configured to leave markings on a surface, may include one or more wheels, for example, omni-wheels and a controller to control the various functions of the self-propelled printer/imprinter. The controller receives printing data in an appropriate format and renders the printing data for the purposes of printing on the surface. The controller typically receives information regarding the location of a head of the self-propelled printer over the surface. In some embodiments, the controller may be further capable of determining the location of the head on the surface autonomously via sensing devices included in the self-propelled printer. According to an embodiment, the controller causes the motion of the self-propelled printer/imprinter over the surface in an efficient path that avoids unnecessary passage over areas that will not be printed upon as well as passage over recently printed-upon areas. Surfaces which may be imprinted upon include, but are not limited to, paper, cloth, floor, tile, a wood, a ceiling, a wall, a window, a glass concrete, and so on.

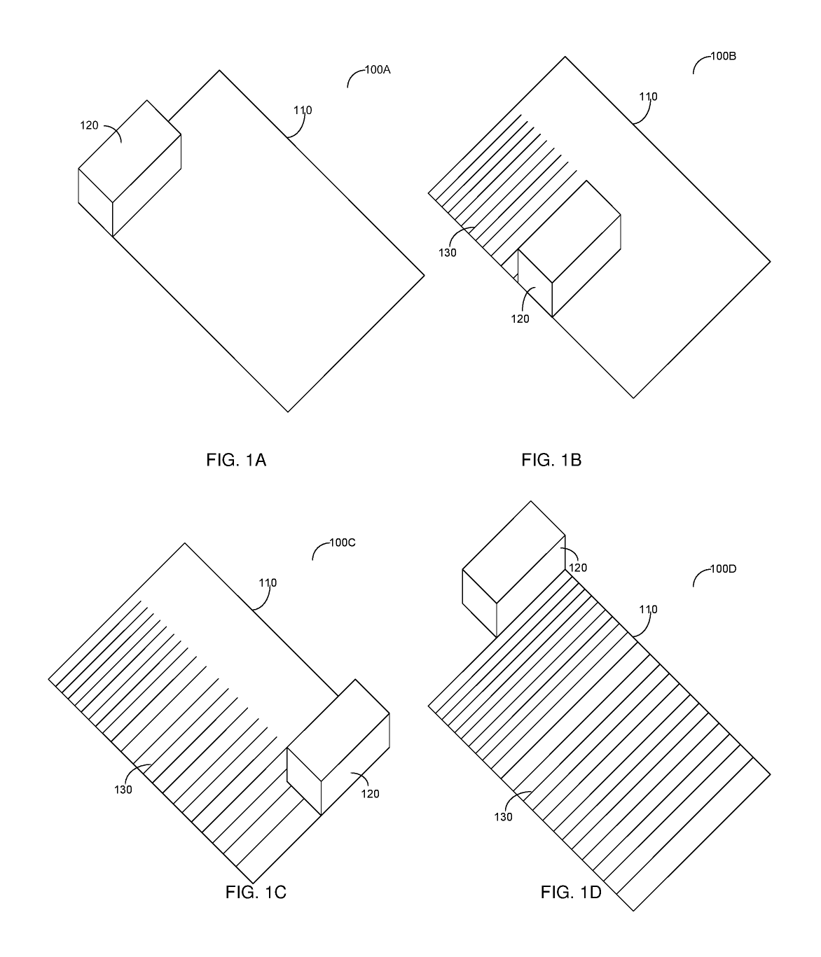

FIGS. 1A through 1D show various stages of an exemplary and non-limiting printing of a page 110 by a self-propelled printer 120 according to an embodiment. In FIG. 1A, the self-propelled printer 120 is positioned at the upper left corner of the page 110. It should be noted that the page 110 may be any surface including, but not limited to, paper, cloth, floor, tile, concrete, and so on. As a non-limiting example, the page 110 is a sheet of paper. Upon receiving printing instructions, the self-propelled printer 120 begins to move along the page 110 in a downward direction toward the bottom of the page, printing at the maximum possible width of the self-propelled printer 120. FIG. 1B shows the self-propelled printer 120 after printing slightly beyond the middle of the left hand side of the page 110, thereby leaving behind printed area 130.

FIG. 1C shows the position of the self-propelled printer 120 after printing the entire left side of the page 110. After printing the entire left side of the page 110, under the control of a controller (not shown) responsible for controlling the motion of the self-propelled printer 120, the self-propelled printer 120 moves horizontally. After moving horizontally, the self-propelled printer 120 begins printing in the opposite direction, i.e., toward the top of the page 110.

FIG. 1D shows the self-propelled printer 120 at its resting point after completion of printing of both side of the page 110. It should be noted that, in these exemplary figures, the resting point of the self-propelled printer 120 is at the top right of the page 110, without any limitation on the disclosed embodiments. The self-propelled printer may start or end at any position on the page 110 and move respective thereon to print the entire area to be printed without departing from the disclosed embodiments. Moreover, though the directions are described as going from the top of the page downward, then horizontally and upward should not be viewed as a limitation. Accordingly, the self-propelled printer 120 may move in multiple or different directions as may be deemed necessary.

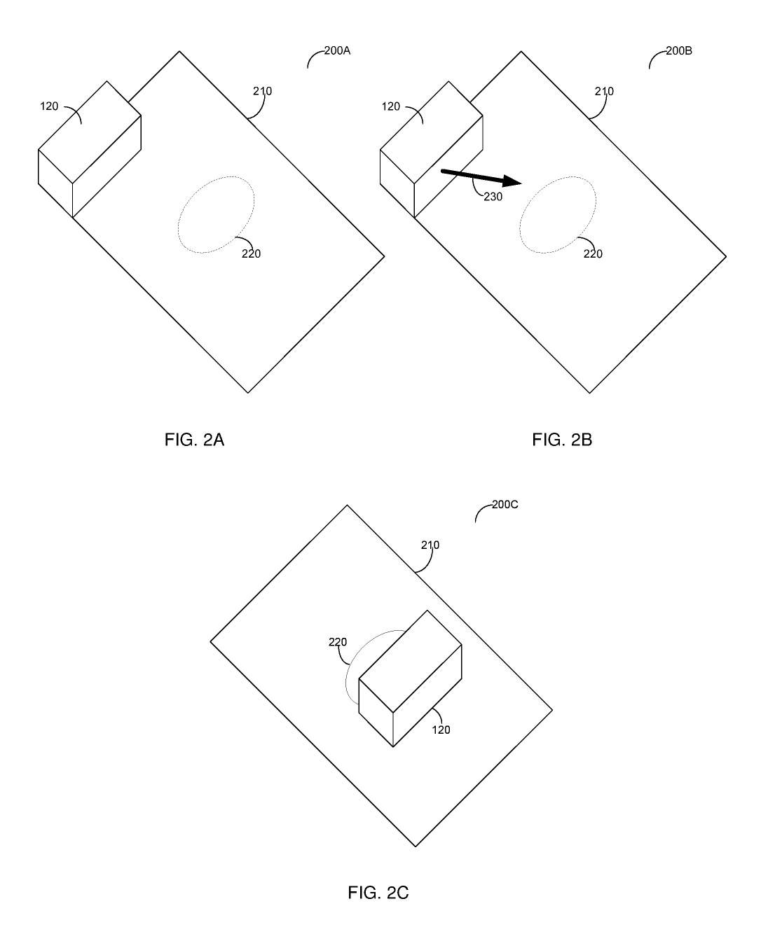

FIGS. 2A through 2C show an exemplary and non-limiting printing of a page 110 by a self-propelled printer 120 according to an embodiment. The starting position of the self-propelled printer 120 is the same as in the previous example (i.e., the top left corner of the page 110) as shown in FIG. 2A. In this case, however, the controller (not shown) of the self-propelled printer 120 is instructed to print solely an ellipse 220 on the page 210. As shown in FIG. 2B, the controller of the self-propelled printer 120 instructs the self-propelled printer 120 to move toward the position where the ellipse 220 should be printed. According to various embodiments, it is not necessary for the self-propelled printer 120 to move across the entire page systematically and only print when reaching the desired printing location. Rather, the self-propelled printer 120 can move directly to the area(s) of page 210 to be printed upon, thereby conserving time and energy that would otherwise be spent on moving around the entire page 210.

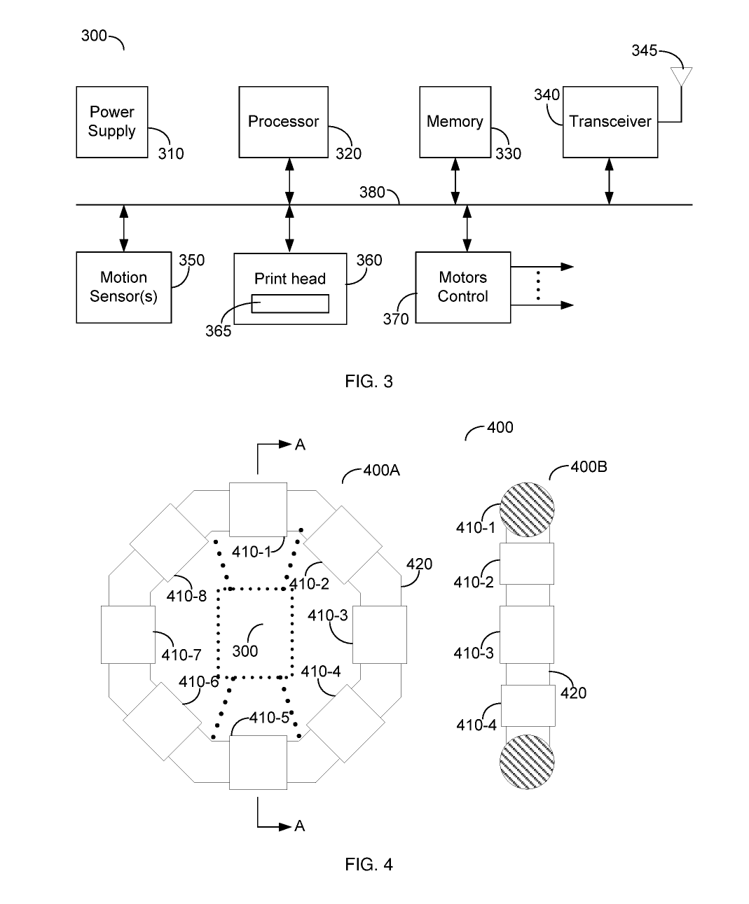

FIG. 3 illustrates an exemplary and non-limiting block diagram of a self-propelled printer 300 according to an embodiment. In one embodiment, the self-propelled printer 300 comprises a power supply 310 such as, for example, a non-rechargeable battery or a rechargeable battery, that allows for the self-propelled printer 300 to operate without being wired to a power source. However, in other embodiments, power may be supplied from an external power source including, but not limited to, a universal serial bus (USB) cable (not shown), that may be further used to provide data to the self-propelled printer 300.

The self-propelled printer 300 also includes a processor 320 and a memory 330. The memory 330 is communicatively connected to the processor 320 by, for example, a bus 380. This communicative connection allows the processor 320 to read instructions stored in the memory 330 as well as to read data from and write data to the memory 330. In one embodiment, processing on the self-propelled printer 300 is limited and most of the processing is performed on the device sending the printed material. For example, a smartphone having installed thereon an appropriate driver operative with respect to the self-propelled printer may perform the majority of processing for the self-propelled printer.

A transceiver 340 connected to an antenna 345 provides a communication link enabling the processor 320 to receive data therefrom through the bus 380 that is communicatively connected to the transceiver 340. Communication can be accomplished via, e.g., WiFi, Bluetooth®, infrared (IR) and other radio frequency (RF) communications, and any other wireless communication links. The transceiver 340 may be used in conjunction with a USB cable, for example, as an alternate means of communication, or in place thereof. It should be understood that embodiments lacking the transceiver 340 may be utilized without departing from the scope of the disclosed embodiments.

A print head 360 that provides one or more slots for placement of ink cartridges is further connected to the bus. The ink cartridges contain ink that is used for the purpose of printing. Ink contained in the ink cartridges may be, but is not limited to, black ink, colored ink, invisible ink, chemicals, medicines, edible ink, etc. It should be noted that the embodiment described with respect to FIG. 3 includes ink cartridges merely for the sake of example and without limitation on the various disclosed embodiments. Other forms of marking may be used without departing from the scope of the disclosed embodiments. Such forms of marking may or may not come packaged in cartridges.

Printing is performed under the control of the processor 320. In another embodiment, instead of cartridges, a user may inject ink into certain cavities of the print head 360. While FIG. 3 is described with respect to ink cartridges, it is merely described as such for simplicity sake and does not limit any of the various disclosed embodiments. Other printing techniques, for example and without limitation, thermal printing, are also possible without departing from the scope of the disclosed embodiments.

The advantages of the self-propelled printer 300 become further evident when the motor controls used to control the motion of the self-propelled printer 300 are discussed. Specifically, the motors control unit 370 is communicatively connected to the bus 380 and operates under the instructions of the processor 320.

FIG. 4 depicts an exemplary and non-limiting diagram of a top view 400A and a cross-section view 400B of an omni-wheel 400 used to control the motion of a self-propelled printer (e.g., the self-propelled printer 120) according to an embodiment. The omni-wheel 400 is capable of moving in all directions depending on the movement of wheels 410-1 through 410-8 (hereinafter referred to individually as a wheel 410 and collectively as wheels 410) that are mounted on the body 420 and may contain therein the necessary motors for the operation of the omni-wheel 400. It should be noted that the embodiment described with respect to FIG. 4 has 8 wheels 410 merely for illustrative purposes and without any limitations on the disclosed embodiments. More or fewer wheels 410 may be used without departing from the scope of the disclosed embodiments.

For illustration purposes, the self-propelled printer 300 is mounted on the wheel as shown in FIG. 4. By causing, for example, wheels 410-1 and 410-5 to turn in the same direction, the omni-wheel 400 will move in a vertical direction along the paper, while if wheels 410-2 and 410-6 turn in the same direction, the omni-wheel 400 will move in a diagonal direction. While a single omni-wheel 400 is shown herein, other embodiments are possible where two or more omni-wheels are mounted to the self-propelled printer 300.

Returning to FIG. 3, it is the task of the motors control unit 370 to control the motors that propel the self-propelled printer 300 (e.g., the motors of the wheels 410). In one embodiment, the self-propelled printer 300 further comprises one or more sensors that enable the self-propelled printer 300 to determine its position including, but not limited to, changes in position with respect to its motion, the location of the print head 360 with respect to the page, and the like. It should be understood that other sensors may be used such as, for example, color sensors to determine the color of the surface upon which the self-propelled printer 300 is operating over. A color sensor may be used, for example, to determine crossing from a printing surface to another surface based on changes in detected colors. While an omni-wheel solution is discussed herein, it should be noted that the invention may be realized using other wheel structures as well as structures such as continuous track mechanisms. Such alternative mechanisms should provide the self-propelled printer 300 with the capability of moving in at least X and Y directions on a surface.

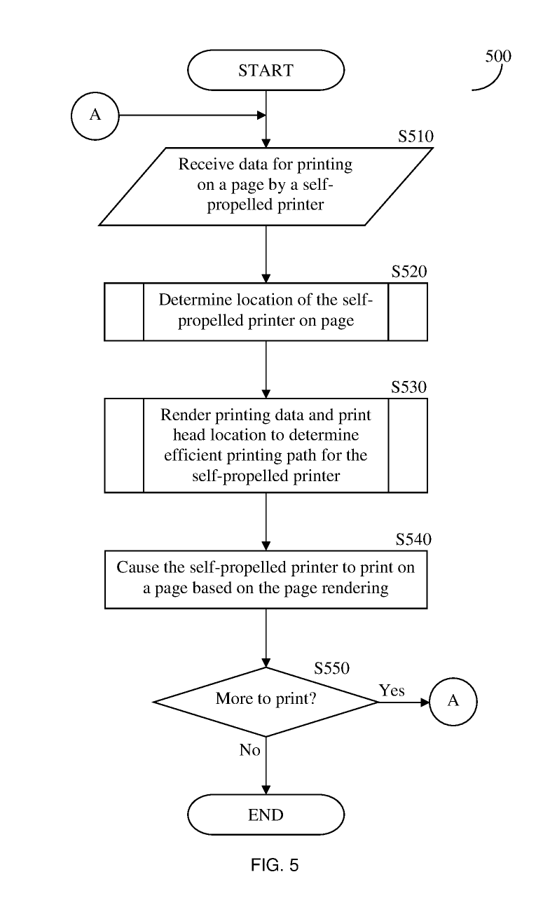

FIG. 5 shows an exemplary and non-limiting flowchart 500 describing the operation of a self-propelled printer (e.g., the self-propelled printer 300) according to an embodiment. In S510, the self-propelled printer receives data for printing. Data for printing may include, but is not limited to, the size and shape of area(s) on a surface to be printed upon, color(s) to be used in printing, a size and shape of the surface to be printed upon, a type of the surface to be printed upon (e.g., paper, cloth, etc.), and so on.

In S520, the position of a print head (e.g., the print head 360) of the printer with respect to the surface to be printed upon (e.g., the page 110) is determined. The determination of the position may be done manually by a user through a user interface, or by using sensors (e.g., the sensors 350) of the self-propelled printer. The sensors may be motion sensors, navigation sensors, and other sensors used as inputs that have an impact on the guiding of the self-propelled printer 300.

In S530, the self-propelled printer 300 renders printing data respective of the data for printing and the position of the print head. The rendering not only determines which ink dots to make on the paper, but also determine an efficient manner of approaching the areas to be printed upon while avoiding unnecessary passage over areas that do not currently require printing. By attempting to approach only areas that will be printed upon, the self-propelling printer may print more quickly and efficiently.

As a non-limiting example of efficiently approaching an area to be printed, consider the page 210 as described with respect to FIG. 2A. The self-propelled printer 120 is located diagonally from the sole area to be printed upon, the ellipse 220. Based on detection of the self-propelled printer 120's current location (the top left corner of the page), it is determined that the self-propelled printer 120's center is one inch north and one inch west of the center of the ellipse 220. Accordingly, it is determined that a direct line to the ellipse 220 would involve moving roughly 1.4 inches at a 45 degree angle south from east. Once at the location of the ellipse 220, the self-propelled printer 120 moves so as to mark the ellipse 220 with ink.

In S540, print instructions are performed by the self-propelled printer. In S550, it is checked whether additional printing is necessary and if so execution continues with S510; otherwise, execution terminates. It should be understood that, although the description herein refers to a paper as the surface that is printed upon, other materials such as, for example, a variety of cloths, may also be considered a printing surface.

While the embodiments discussed hereinabove were particular to a print head in a self-propelled printer, other embodiments are possible without departing from the scope of the invention. Different printing mechanism may be used, including but not limited to thermal printing and LASER printing. The self-propelled printer may be further adapted to operate as an imprinter, for example, for the purpose of engraving into a surface rather than printing thereon. Surfaces may further vary and include, but are not limited to, paper, cloth, tiles, floors, concrete, and other surfaces capable of being printed or imprinted upon. While an omni-wheel was described herein, other motion capable surfaces are possible such as, but not limited to, a wheel and a traction chain.

The various embodiments may be implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal. The display segments and mini-display segments may be shown on a display area that can be a browser or another other appropriate graphical user interface of an application, for example, an internet mobile application, either generic or tailored for the purposes described in detail hereinabove.

All examples and conditional language recited herein are intended for pedagogical purposes to aid the reader in understanding the principles and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A self-propelled printer, comprising:
a processor;
an interface communicatively connected to the processor for providing at least information respective of a surface to be printed;
a memory communicatively connected to the processor, the memory containing instructions that, when executed by the processor, configure the self-propelled printer to at least render an image for printing respective of at least a portion of the information received via the interface;
a print head communicatively connected to the processer for printing on the surface based on the rendered image;
a motor control unit communicatively connected to the processor for propelling the self-propelled printer via at least one motor based on the rendered image; and
at least a rotary element connected to the at least one motor, wherein the rotary element is configured to move in at least two directions with respect to the surface based on movement of the at least one motor.

2. The self-propelled printer of claim 1, wherein the surface is any one of: a paper, a cloth, a floor, a tile, a wood, a ceiling, a wall, a window, a glass and concrete.

3. The self-propelled printer of claim 1, wherein the at least a rotary element comprises an omni-wheel.

4. The self-propelled printer of claim 1, wherein the self-propelled printer is further configured to:
determine a location of the self-propelled printer on the surface.

5. The self-propelled printer of claim 1, wherein the rendered image only includes at least a portion of the surface that has not been previously printed upon.

6. The self-propelled printer of claim 1, wherein the interface is at least one of: a WiFi interface, a Bluetooth interface, an infrared interface, a radio frequency interface, a wireless interface, a wired interface, and a universal serial bus (USB) interface.

7. The self-propelled printer of claim 1, further comprising:
a battery.

8. The self-propelled printer of claim 7, wherein the battery is a rechargeable battery.

9. A self-propelled imprinter, comprising:
a processor;
an interface communicatively connected to the processor for providing at least information respective of a surface to be imprinted;
a memory communicatively connected to the processor, the memory containing instructions that, when executed by the processor configure the self-propelled imprinter to at least render an image for imprinting respective of at least a portion of the information received via the interface;
an imprinter head communicatively connected to the processer for imprinting on the surface based on the rendered image;
a motor control unit communicatively connected to the processor for propelling the self-propelled imprinter via at least one motor based on the rendered image; and
at least a rotary element connected to the at least one motor, wherein the rotary element is configured to move in at least two directions with respect to the surface based on movement of the at least one motor.

10. The self-propelled imprinter of claim 9, wherein the surface is any one of: a paper, a cloth, a floor, a tile, a wood, a ceiling, a wall, a window, a glass and concrete.

11. The self-propelled imprinter of claim 9, wherein the at least a rotary element comprises an omni-wheel.

12. The self-propelled imprinter of claim 9, wherein the self-propelled imprinter is further configured to determine a location of the self-propelled imprinter on the surface.

13. The self-propelled imprinter of claim 9, wherein the rendered image only includes at least a portion of the surface that has not been previously imprinted upon.

14. The self-propelled imprinter of claim 9, wherein the interface is at least one of: a WiFi interface, a Bluetooth interface, an infrared interface, a radio frequency interface, a wireless interface, a wired interface, and a universal serial bus (USB) interface.

15. The self-propelled printer of claim 9, further comprising a battery.

16. The self-propelled printer of claim 15, wherein the battery is a rechargeable battery.
